(19) United States
(12) Patent Application Publication
(10) Pub. No.: US 2017/0120978 A1
(43) Pub. Date: May 4, 2017

(54) TWO-WHEELED VEHICLE HISTORY AND LOSS MANAGEMENT METHOD USING BLE AND WIRELESS COMMUNICATION AND SYSTEM THEREFOR

(71) Applicant: INDUSTRIAL BANK OF KOREA, Seoul (KR)

(72) Inventors: Pilsoon SHIN, Busan (KR); Jongman KWON, Gwangju-si (KR)

(21) Appl. No.: 14/927,271

(22) Filed: Oct. 29, 2015

(51) Int. Cl. B62H 5/20; H04W 4/00; H04L 29/08

(52) U.S. Cl. CPC B62H 5/20; H04L 67/26; H04W 4/008

(57) ABSTRACT

The present invention relates to a two-wheeled vehicle history and loss management method using BLE and wireless communication and system therefor. The present invention provides a two-wheeled vehicle history and loss management system using BLE and wireless communication that includes a non-communication type beacon sensor (10a) or a communication type beacon sensor (10b) attached to a handle of a two-wheeled vehicle and a user mobile terminal (80) in which a user's app is installed, the system including: broadcasting a beacon ID through a beacon transmitting unit (11) according to generation of movement sensing information of the two-wheeled vehicle by an accelerometer (13) of the non-communication type beacon sensor (10a) or the communication type beacon sensor (10b), transmitting the beacon ID to the user mobile terminal (80) through BLE communication using a push message, and implementing the push message as a UI screen by the user's app.

### BACKGROUND

1. Field of the Invention

The present invention relates to a two-wheeled vehicle history and loss management method using BLE and wireless communication and system therefor, and more specifically, to a two-wheeled vehicle history and loss management method using BLE and wireless communication and system therefor in which a two-wheeled vehicle antitheft service based on information technology (IT) is provided, a two-wheeled vehicle crime countermeasure is established and a bicycle leisure market is revitalized.

2. Discussion of Related Art

With construction and policy support of bicycle roads, bicycle leisure culture is quickly spreading and an era of 10 million bicycles has begun.

The size of the bicycle market exceeded half a trillion KRW in 2012. Middle-and high-end bicycles of 200,000 KRW or more are main models in the industry and occupy more than 40% of total sales. High-end bicycles of 500,000 KRW or more have gone on to occupy a proportion of the market as high as, for example, 10% or more. Therefore, according to an increase of high-end bicycles, the necessity to prevent bicycle loss due to theft is increasing.

Currently, damages from bicycle theft is significantly increasing. With the increase in the values of bicycles described above, bicycle theft more than tripled from 4,915 cases in 2008 to 15,774 cases in 2013 (the National Police Agency, 2014 statistics). Further, due to characteristics of bicycles, bicycles are likely to be kept outdoors where they are easy targets for crime, and a ratio of minors is higher in bicycle crimes than other crimes, and an effect of legal regulation is low.

Meanwhile, since high-end bicycles have a vehicle identification number, it is possible to check an owner. However, bicycle searching depends on reports or direct searching, which is inefficient and has a low return rate. Since general middle-and low-end bicycles does not have license plate or vehicle identification number, a return rate after theft is low.

In addition, due to characteristics of separable products according to the nature of bicycles, there is a problem of mechanical features in that only a locked part need be taken off in order to take the bicycle.

Therefore, as in the relevant art, there is an urgent need to develop technology for preventing not only bicycles, but two-wheeled vehicles in general including motorcycles from being stolen and managing a history of the two-wheeled vehicle itself.

### SUMMARY OF THE INVENTION

In view of the above-described problems, the present invention provides a two-wheeled vehicle history and loss management method using BLE and wireless communication and system therefor in which a two-wheeled vehicle antitheft service is provided based on BLE communication between a beacon sensor and a mobile terminal, a two-wheeled vehicle crime countermeasure is established and a two-wheeled vehicle leisure market is revitalized.

The present invention also provides a two-wheeled vehicle history and loss management method using BLE and wireless communication and system therefor in which a real time monitoring method of a two-wheeled vehicle based on movement detection, and a location-based service, and an additional service for healthcare are provided.

However, objects of the present invention are not limited thereto, and other unmentioned objects may be clearly understood by those skilled in the art from the following descriptions.

In view of the above-described objects, according to an embodiment of the present invention, there is provided a two-wheeled vehicle history and loss management system using BLE and wireless communication that includes a non-communication type beacon sensor (10a) or a communication type beacon sensor (10b) attached to a handle of a two-wheeled vehicle and a user mobile terminal (80) in which a user's app is installed, the system including: broadcasting a beacon ID through a beacon transmitting unit (11) according to generation of movement sensing information of the two-wheeled vehicle by an accelerometer (13) of the non-communication type beacon sensor (10a) or the communication type beacon sensor (10b), transmitting the beacon ID to the user mobile terminal (80) through BLE communication using a push message, and implementing the push message as a UI screen by the user's app.

The non-communication type beacon sensor (10a) or the communication type beacon sensor (10b) may further include a 1600 mA battery (14) configured to supply power to the beacon transmitting unit (11), a control unit (12) and the accelerometer (13).

The communication type beacon sensor (10b) may further include a wireless communication module (16) configured to transmit movement sensing information and the beacon ID to a target object via an IP network (20); and a GPS receiver (15) configured to receive location information from GPS satellites.

The non-communication type beacon sensor (10a) and the communication type beacon sensor (10b) may register the beacon ID in a DB management server (60) according to data transmission with a mobile server (50) through a user's app (80a) and perform history management of the two-wheeled vehicle based on the beacon ID.

In view of the above-described objects, according to another embodiment of the present invention, there is provided a two-wheeled vehicle history and loss management method using BLE and wireless communication, including: a first operation in which a non-communication type beacon sensor (10a) or a communication type beacon sensor (10b) broadcasts a beacon ID through a beacon transmitting unit (11) according to generation of movement sensing information of a two-wheeled vehicle by an accelerometer (13); and a second operation in which the non-communication type beacon sensor (10a) or the communication type beacon sensor (10b) transmits the beacon ID to a user mobile terminal (80) through BLE communication using a push message, and the push message is implemented as a UI screen by a user's app.

The method may further include, before the first operation, registering, by the non-communication type beacon sensor (10a) or the communication type beacon sensor (10b), the beacon ID in a DB management server (60) according to data transmission with a mobile server (50) through a user's app (80a), and performing, by a smart two-wheeled vehicle service platform (40), history management of the two-wheeled vehicle based on the beacon ID.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a two-wheeled vehicle history and loss management system using BLE and wireless communication according to an embodiment of the present invention;

FIG. 2 is a diagram for describing a configuration of a non-communication type beacon sensor in the two-wheeled vehicle history and loss management system using BLE and wireless communication of FIG. 1;

FIG. 3 is a diagram for describing an antitheft and loss prevention service of a two-wheeled vehicle using a non-communication type beacon sensor in a two-wheeled vehicle history and loss management method using BLE and wireless communication according to an embodiment of the present invention;

FIG. 4 is a diagram for describing a two-wheeled vehicle registration and history management service using a non-communication type beacon sensor in a two-wheeled vehicle history and loss management method using BLE and wireless communication according to another embodiment of the present invention;

FIG. 5 is a diagram for describing a configuration of a communication type beacon sensor in the two-wheeled vehicle history and loss management system using BLE and wireless communication of FIG. 1 in a two-wheeled vehicle history and loss management method using BLE and wireless communication according to an embodiment of the present invention;

FIG. 6 is a diagram for describing a location tracking service using a communication type beacon sensor in a two-wheeled vehicle history and loss management method using BLE and wireless communication according to an embodiment of the present invention; and

FIG. 7 is a diagram illustrating a system architecture of a smart two-wheeled vehicle service platform 40 according to an embodiment of the present invention.

### DETAILED DESCRIPTION OF EXEMPLARY EMBODIMENTS

Hereinafter, exemplary embodiments of the present invention will be described in detail with reference to the accompanying drawings. In the following description of the present invention, when it is determined that detailed descriptions of related well-known functions or configurations unnecessarily obscure the gist of the present invention, the detailed descriptions thereof will be omitted.

In this specification, it will be understood that when a component “transmits” data or a signal to another component, the component can directly transmit the data or the signal to another component or can transmit the data or the signal to another component through at least another component.

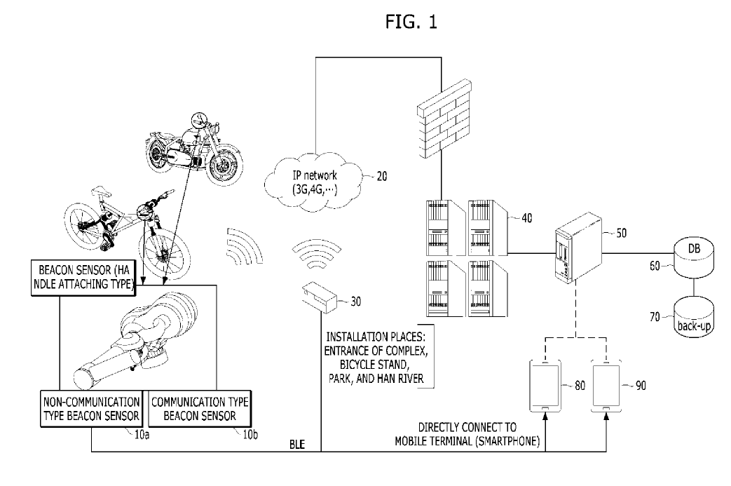

FIG. 1 is a diagram illustrating a two-wheeled vehicle history and loss management system using BLE and wireless communication according to an embodiment of the present invention.

As illustrated in FIG. 1, the two-wheeled vehicle history and loss management system using BLE and wireless communication includes a non-communication type beacon sensor 10a, a communication type beacon sensor 10b, an IP network 20, an access point (hereinafter, referred to as an “AP”) 30, a smart two-wheeled vehicle service platform 40, a mobile server 50, a DB management server 60, a backup server 70, a user mobile terminal 80, and an administrator mobile terminal 90. Here, the IP network 20 is a communication network that is a high speed backbone network of a large communication network through which a high capacity, long distance audio and data service is possible, and may be the Internet or a next generation wired and wireless network for providing a high speed multimedia service. When the IP network 20 is a mobile communication network, it may be a synchronous mobile communication network or an asynchronous mobile communication network. As an embodiment of the asynchronous mobile communication network, a communication network of a Wideband Code Division Multiple Access (WCDMA) scheme may be exemplified. In this case, although not illustrated, a mobile communication network 700 may include a radio network controller (RNC). While a 3G network and a 4G network are exemplified, a next generation communication network, and other IP networks based on an IP may be used.

Also, a user's app 80a is installed in the user mobile terminal 80.The administrator mobile terminal 90is a terminal that an administrator such as a police officer possesses, and an administrator's app (admin's app) 90a is installed therein.

According to such a configuration, the two-wheeled vehicle history and loss management system using BLE and wireless communication provides an integrated two-wheeled vehicle security safety management service based on the Internet of Things (IoT) in which an antitheft and loss prevention service and a two-wheeled vehicle registration and management service for a two-wheeled vehicle are provided through the user's app 80a and the administrator's app 90a based on the non-communication type beacon sensor 10a or the communication type beacon sensor 10b attached to the two-wheeled vehicle.

In the “antitheft and loss prevention service,” when a movement is detected through an accelerometer 13 of the non-communication type beacon sensor 10a and the communication type beacon sensor 10b which are attached to a handle of the two-wheeled vehicle, a push message is provided through the user's notification app 80a in real time. In the communication type beacon sensor 10b, a location tracking service can be provided through communication with the communication type beacon sensor 10b of the two-wheeled vehicle.

Meanwhile, in the “two-wheeled vehicle registration and management service,” beacon IDs of the non-communication type beacon sensor 10a and communication type beacon sensor 10b themselves are transmitted to the smart two-wheeled vehicle service platform 40 using the user's app 80a through data transmission with the mobile server 50, and are registered in the DB management server 60. Therefore, it is possible to perform history management of the two-wheeled vehicle based on the beacon ID.

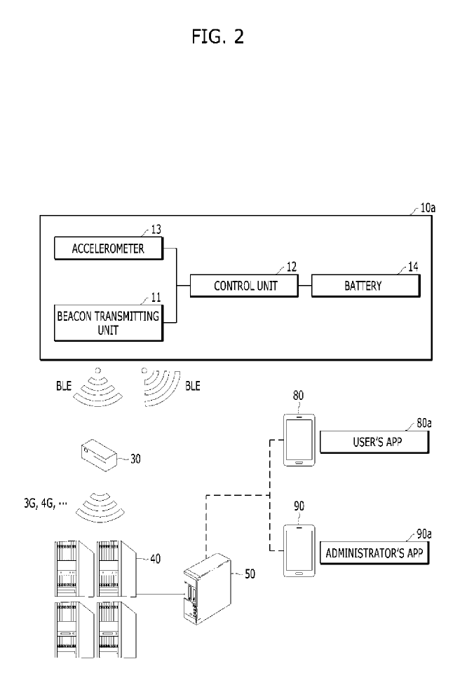

FIG. 2 is a diagram for describing a configuration of the non-communication type beacon sensor 10a in the two-wheeled vehicle history and loss management system using BLE and wireless communication of FIG. 1.

As illustrated in FIG. 2, the non-communication type beacon sensor 10a includes a beacon transmitting unit 11, a control unit 12, the accelerometer 13 and a battery 14.

That is, the non-communication type beacon sensor 10a includes the accelerometer 13 configured to detect a movement of the two-wheeled vehicle, the beacon transmitting unit 11 configured to broadcast “movement sensing information” obtained by the accelerometer 13, and the “beacon ID” stored in a storage unit (not illustrated) as other unique information, the control unit 12, and the 1600 mA battery 14 configured to supply power to the accelerometer 13, and that is attached to the handle of the two-wheeled vehicle. The non-communication type beacon sensor 10a is operated for two or more years using the battery 14, and thus user convenience is maximized.

The following [Table 1] shows configuration units of the non-communication type beacon sensor 10a, and functions of the smart two-wheeled vehicle service platform 40, the AP 30, and the mobile terminals 80 and 90, which are performed based on the non-communication type beacon sensor 10a.

TABLE 1

| Items | | Functions |
|---|---|---|
| Non- | Beacon transmitting unit | broadcasts a beacon ID and |
| communication | 11 | movement sensing |
| type beacon | | information through a BLE |
| sensor 10a | | signal |
| | | [A broadcasting target is |
| | | the user terminal 80 or the |
| | | AP 30 (optional) (when |
| | | there is not the user |
| | | terminal 80 within a |
| | | preset Bluetooth |
| | | communication range)] |
| | Accelerometer 12 | detects a movement of the |
| | | two-wheeled vehicle and |
| | | generates movement |
| | | sensing information |
| | 1600 mA battery 14 | operates for two or more |
| | | years based on a non- |
| | | communication type |
| Smart | ID registration and | registers and manages the |
| two-wheeled | management | two-wheeled vehicle |
| vehicle service | | through matching the user |
| platform 40 | | ID with the beacon ID |
| | History management | manages a history of |
| | | movement sensing |
| | | information, repair |
| | | information, information |
| | | on a place of purchase or |
| | | the like |
| | Relevant organization | connects ID (a model |
| | relation | name, a color or the like) |
| | | report information to a |
| | | relevant organization (a |
| | | police station) |
| AP 30 | Access Point | receives a beacon signal of |
| | | the beacon transmitting |
| | | unit 11 and transmits the |
| | | signal to the smart two- |
| | | wheeled vehicle service |
| | | platform 40 through |
| | | wireless communication |
| | | such as 3G or 4G |
| Mobile | User's app 80a | two-wheeled vehicle |
| terminals | | registration and history |
| 80 and 90 | | management |
| [smart terminal] | | theft and loss reporting |
| | | movement detection push |
| | | messaging |
| | Administrator's app 90a | stolen two-wheeled vehicle |
| | | information viewing |
| | | stolen two-wheeled vehicle |
| | | checking |

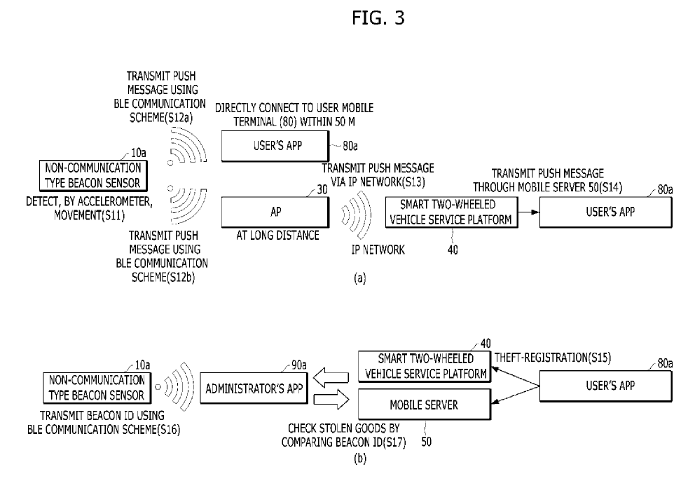

Meanwhile, FIG. 3 is a diagram for describing an antitheft and loss prevention service of the two-wheeled vehicle using the non-communication type beacon sensor 10a of FIG. 2 in the two-wheeled vehicle history and loss management method using BLE and wireless communication according to the embodiment of the present invention.

First, a movement detection and real time notification service in FIG. 3a will be described. When the accelerometer 13 of the non-communication type beacon sensor 10a attached to the two-wheeled vehicle of the user detects a movement, the control unit 12 determines whether the user mobile terminal 80 is within a preset distance (hereinafter, within 50 m) through data transmission and reception using a BLE scheme with the mobile terminal 80 with respect to the beacon transmitting unit 11 (S11).

As a determination result of operation S11, when it is determined that the user mobile terminal 80 is within 50 m, the control unit 12 directly transmits a push message to the user mobile terminal 80 using a BLE communication scheme, and thus enables the push message indicating a warning to be output to a UI screen of the user's app 80a (S12a).

Meanwhile, as a determination result of operation S11, when it is determined that the user mobile terminal 80 is not within 50 m but at a long distance, the control unit 12 transmits the push message and the beacon ID to the AP 30 using the BLE communication scheme (S12b). Therefore, the AP 30 transmits the push message to the smart two-wheeled vehicle service platform 40 via the IP network 20 (S13), and thus the push message is transmitted to the user mobile terminal 80 through the mobile server 50 (S14). As a result, the push message indicating a warning is output to the UI screen of the user's app 80a.

That is, the non-communication type beacon sensor 10a is directly connected to and communicates with the user mobile terminal 80 at a short distance. It is possible to provide a two-wheeled vehicle antitheft and loss prevention service through the AP 30 to be installed at various places such as a home, a complex two-wheeled vehicle parking lot, a two-wheeled vehicle stand, or a park at a long distance.

Next, a stolen two-wheeled vehicle check and search service in FIG. 3b will be described. The user's app 80a of the user mobile terminal 80 registers the beacon ID in the smart two-wheeled vehicle service platform 40 via the IP network 20 and selectively registers the beacon ID in the mobile server 50 in case of theft of the two-wheeled vehicle, and thus theft-registration is performed (S15).

Then, when the administrator's app 90a of the administrator mobile terminal 90receives the beacon ID from the non-communication type beacon sensor 10a using the BLE communication scheme (S16), the administrator's app 90a may output a checked result of the stolen two-wheeled vehicle that is obtained by comparing the theft-registered beacon ID with the beacon ID received in operation S16 to the UI screen (S17).

Meanwhile, as another embodiment of the present invention, between operations S15 and S16, the smart two-wheeled vehicle service platform 40 and the mobile server 50 may enable theft-registration to be performed in the administrator's app 90a that is driven in the administrator mobile terminal 90that a police officer or the like possesses via the IP network 20.

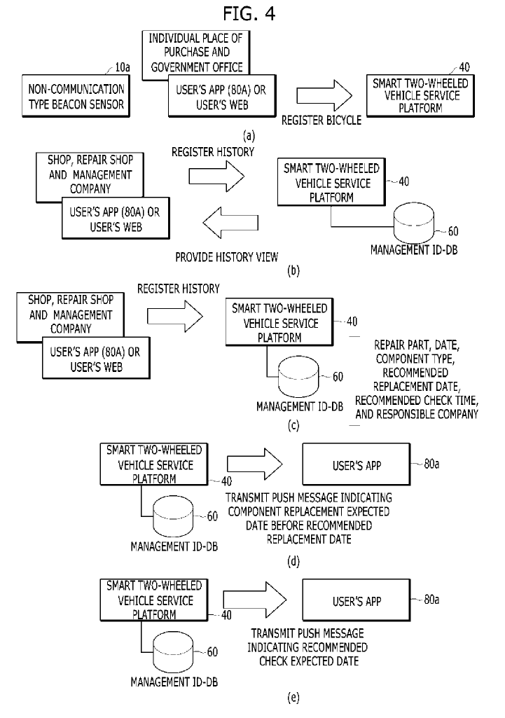

FIG. 4 is a diagram for describing a two-wheeled vehicle registration and history management service using the non-communication type beacon sensor 10a of FIG. 2 in the two-wheeled vehicle history and loss management method using BLE and wireless communication according to another embodiment of the present invention.

As illustrated in FIG. 4, the non-communication type beacon sensor 10a may provide a two-wheeled vehicle registration service in which a beacon ID broadcast function of the beacon transmitting unit 11 is used and a unique ID is assigned and managed for each two-wheeled vehicle, and a history management service in which buying, component, and management information are connected.

That is, the two-wheeled vehicle registration service of FIG. 4a will be described. The two-wheeled vehicle obtained in an individual place of purchase and a government office are connected to the user's web provided in the smart two-wheeled vehicle service platform 40 through the user's app 80a of the user mobile terminal 80 or the mobile terminal 80 via the IP network 20, and the beacon ID is transmitted. Therefore, the two-wheeled vehicle may be registered.

Next, the history management service of FIG. 4b will be described. In shops, repair shops and management companies, a history of the sold, repaired or managed two-wheeled vehicle is transmitted as history information through the user's app 80a of the user mobile terminal 80 or the mobile terminal 80 to the user's web provided in the smart two-wheeled vehicle service platform 40 via the IP network 20, and thus history registration may be performed in a management ID-DB by the DB management server 60. Also, the registered history information may be viewed using the user mobile terminal 80.

Meanwhile, FIGS. 4c to 4e illustrate a history management utilization service. Sequentially, in FIG. 4c, items registered in the management ID-DB in FIG. 4b may include a repair part, a service providing date, a component type, a recommended replacement date, a recommended check time, and a responsible company.

Next, as illustrated in FIG. 4d, the smart two-wheeled vehicle service platform 40 enables a component replacement expected date before the recommended replacement date of FIG. 4c to be transmitted to the user mobile terminal 80 via the IP network 20 using a notification push message, and to be implemented as the UI screen by the user's app 80a.

As illustrated in FIG. 4e, the smart two-wheeled vehicle service platform 40 reads a recommended check time in FIG. 4c from a DB managed by the DB management server 60, transmits the recommended check time to the user mobile terminal 80 using a notification push message via the IP network 20 before a recommended check expected date, and implements it as the UI screen by the user's app 80a.

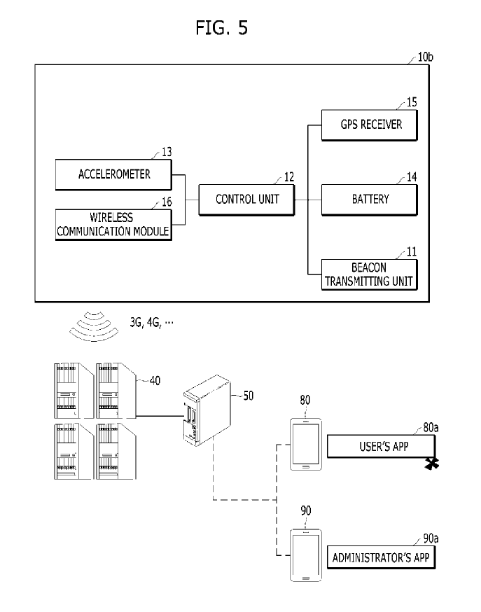

FIG. 5 is a diagram for describing a configuration of the communication type beacon sensor 10b in the two-wheeled vehicle history and loss management system using BLE and wireless communication of FIG. 1 in the two-wheeled vehicle history and loss management method using BLE and wireless communication according to the embodiment of the present invention. As illustrated in FIGS. 2 and 5, the communication type beacon sensor 10b further includes a GPS receiver 15 and a wireless communication module 16 in addition to the beacon transmitting unit 11, the control unit 12, the accelerometer 13 and the battery 14 which are components of the non-communication type beacon sensor 10a of FIG. 2.

That is, the communication type beacon sensor 10b includes the accelerometer 13 configured to detect a movement of the two-wheeled vehicle, the beacon transmitting unit 11 configured to broadcast “movement sensing information” obtained by the accelerometer 13 and the “beacon ID” stored in a storage unit (not illustrated) as other unique information, and the 1600 mA battery 14 configured to supply power to the beacon transmitting unit 11, the control unit 12, the accelerometer 13, the GPS receiver 15 and the wireless communication module 16, and is attached to a handle of the two-wheeled vehicle.

Here, the wireless communication module 16 transmits the above-described movement sensing information and beacon ID to a target object through wireless communication such as 3G or 4G via the IP network 20, and the GPS receiver 15 receives location information from GPS satellites.

The following [Table 2] shows configuration units of the communication type beacon sensor 10b and functions of the smart two-wheeled vehicle service platform 40 and the mobile terminals 80 and 90, which are performed based on the communication type beacon sensor 10b.

TABLE 2

| Items | | Functions |
|---|---|---|
| Non- | Beacon transmitting unit | broadcasts a beacon ID and |
| communication | 11 | movement sensing |
| type beacon | | information through a BLE |
| sensor 10b | | signal |
| | Accelerometer 13 | detects a movement of the |
| | | two-wheeled vehicle |
| | GPS receiver 15 | receives location |
| | | information |
| | Wireless communication | transmits GPS location |
| | module 16 | information to the smart |
| | | two-wheeled vehicle |
| | | service platform 40 when a |
| | | movement is detected |
| | Battery 14 | recharging is necessary |
| | | within 1 to 3 days |
| Smart | ID registration and | registers and manages the |
| two-wheeled | management | two-wheeled vehicle |
| vehicle | | through matching the user |
| service | | ID with the beacon ID. |
| platform 40 | History management | manages a history of |
| | | movement sensing |
| | | information, repair |
| | | information, information |
| | | on a place of purchase or |
| | | the like |
| | Relevant organization | Connects report |
| | connection | information including |
| | | location information to a |
| | | relevant organization (a |
| | | police station) |
| Mobile | Administrator's app 90a | support location tracking |
| terminals | user's app 80a | service |
| 80 and 90 | | the same as other non- |
| [smart terminal] | | communication type |
| | | services |

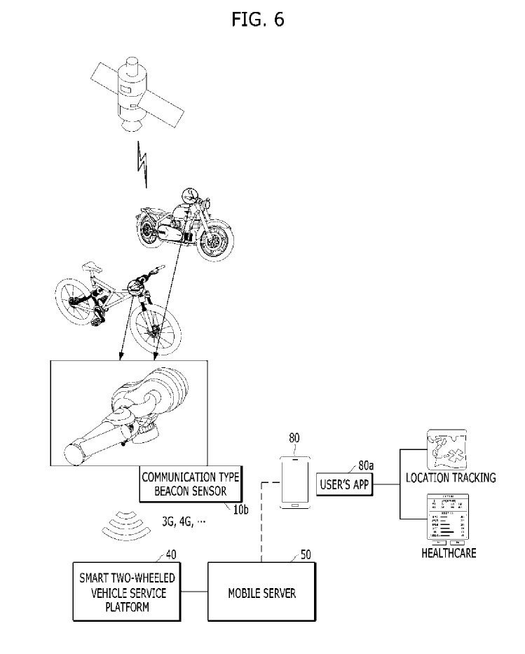

FIG. 6 is a diagram for describing a location tracking service using the communication type beacon sensor 10b of FIG. 5 in a two-wheeled vehicle history and loss management method using BLE and wireless communication according to an embodiment of the present invention.

As illustrated in FIG. 6, the communication type beacon sensor 10b transmits GPS location information received by the GPS receiver 15 together with a support service of the non-communication type beacon sensor 10a described in FIG. 3 via the IP network 20 through which 3G, 4G, and other wireless communication are provided, and transmits the information to the user mobile terminal 80 through the smart two-wheeled vehicle service platform 40. Therefore, the user's app 80a provides and outputs an identifiable location tracking service and a healthcare service utilizing the same for the user through the UI screen.

The following [Table 3] shows functions of a location tracking service provided by the communication type beacon sensor 10 and a healthcare service utilizing the same.

TABLE 3

| Items | | Functions |
|---|---|---|
| Location | GPS location | GPS location information |
| tracking | information | periodically is transmitted to the IP |
| service | | network 20 corresponding to 3G or |
| | | 4G, and is output through the |
| | | user's app 80a |
| | Location history | enables a location information |
| | information viewing | history stored by the smart two- |
| | | wheeled vehicle service platform |
| | | 40 corresponding to a platform |
| | | server to be checked through the |
| | | user's app 80a |
| Healthcare | Diet | provides information on a calorie |
| service | | consumption through GPS |
| | | distance/speed calculation and |
| | | efficient two-wheeled vehicle diet |
| | Trace | provides a view function such as |
| | | various speeds, a slope, and a break |
| | | time with respect to a movement |
| | | distance and path along which a |
| | | user moves while aboard the two- |
| | | wheeled vehicle using GPS |
| | Tour and hiking | provides a recommended path and |
| | | search for a nearby two-wheeled |
| | | vehicle road |

As described above, comparison of the non-communication type beacon sensor 10a and the communication type beacon sensor 10b used in the two-wheeled vehicle history and loss management method using BLE and wireless communication and system therefor is shown in the following [Table 4].

TABLE 4

| Sections | Non-communication type | Communication type |
|---|---|---|
| Configuration | beacon transmitting unit 11 | beacon transmitting unit 11 |
| | control unit 12 | control unit 12 |
| | accelerometer 13 | accelerometer 13 |
| | battery 14 | battery 14 |
| | | GPS receiver 15 |
| | | wireless communication |
| | | module 16 |
| Provided services | antitheft and loss prevention | antitheft and loss prevention |
| | service | service |
| | two-wheeled vehicle | two-wheeled vehicle |
| | registration and history | registration and history |
| | management service | management service |
| | | location tracking service |
| Need of AP 30 | unnecessary at a short | x |
| | distance (directly connects | |
| | to the user mobile terminal | |
| | 80 corresponding to a | |
| | smartphone within 50 m) | |
| | provides a notification | |
| | service through the AP 30 | |
| | when parking is performed | |
| | at a long distance | |
| Application ranges | general public storage | No limitation |
| | places of the two-wheeled | |
| | vehicle such as a home, a | |
| | complex two-wheeled | |
| | vehicle parking lot, a two- | |
| | wheeled vehicle stand, and a | |
| | park | |
| Battery duration | two or more years (based on | 1 to 3 days (based on 1600 mA) |
| | 1600 mA) | |

The non-communication type beacon sensor 10a and the communication type beacon sensor 10b may be selectively used according to preference. That is, the non-communication type beacon sensor 10a in which a key function is optimized and management convenience is maximized and the communication type beacon sensor 10b in which a location-based service is provided may be distinguished and thus all needs of a user may be satisfied.

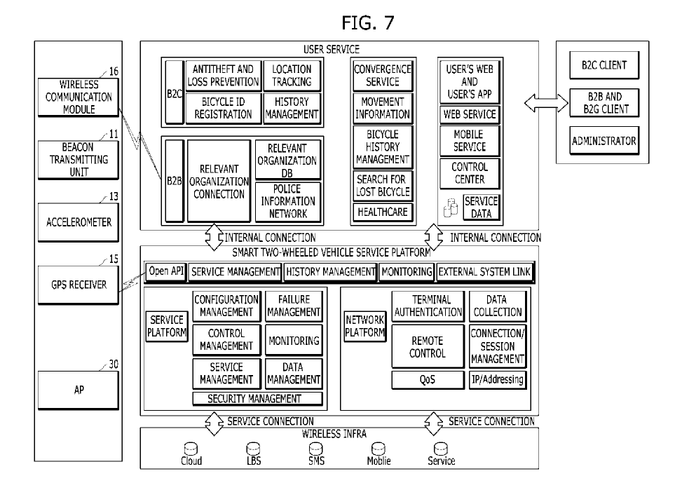

FIG. 7 is a diagram illustrating a system architecture of the smart two-wheeled vehicle service platform 40 according to an embodiment of the present invention.

As illustrated in FIG. 7, the smart two-wheeled vehicle service platform 40 includes a service platform and a network platform. The service platform performs configuration management, failure management, control management, monitoring, service management, data management, security management and the like. The network platform performs terminal authentication, data collection, remote control, connection and session management, QoS, IP/Addressing and the like. In such a configuration, the smart two-wheeled vehicle service platform 40 is optimized for sensor signal collection of various sensor devices of the non-communication type beacon sensor 10a and the communication type beacon sensor 10b and beacon ID-based big data management.

The two-wheeled vehicle history and loss management method using BLE and wireless communication and system therefor according to the embodiment of the present invention can provide a two-wheeled vehicle antitheft service based on BLE communication between a beacon sensor and a mobile terminal, and thus a two-wheeled vehicle crime countermeasure can be established and the two-wheeled vehicle leisure market can be revitalized.

In addition, the two-wheeled vehicle history and loss management method using BLE and wireless communication and system therefor according to another embodiment of the present invention can provide a real time monitoring method of the two-wheeled vehicle based on movement detection and a location-based service and an additional service for healthcare.

The present invention may also be implemented as computer readable codes in a computer readable recording medium. The computer readable recording medium includes any type of a recording device in which data that can be read by a computer system is stored.

Examples of the computer readable recording medium include a ROM, a RAM, a CD-ROM, a magnetic tape, a floppy disk, and an optical data storage device, and also include implementation in the form of a carrier wave (for example, transmission via the Internet).

Also, the computer readable recording medium may be distributed in computer systems connected via a network and the computer readable code may be stored and executed in a distributed manner. Also, functional programs, codes and code segments for implementing the present invention may be easily construed by programmers skilled in the art to which the present invention pertains.

As described above, while the specification and drawings describe exemplary embodiments of the invention and specific terms are used in the specification and drawings, these are used with general meanings to easily describe technological content of the invention and to help understanding of the invention, and the invention is not limited thereto. It is clear to those skilled in the art that various modifications based on the technological scope of the invention in addition to the embodiments disclosed herein can be made.

### REFERENCE NUMERALS

10a: non-communication type beacon sensor
10b: communication type beacon sensor
11: beacon transmitting unit
12: control unit
13: accelerometer
14: battery
15: GPS receiver
16: wireless communication module
20: IP network
30: access point
40: smart two-wheeled vehicle service platform
50: mobile server
60: DB management server
70: backup server
80: user mobile terminal
80a: user's app
90: administrator mobile terminal
90a: administrator's app (Admin's App.)

What is claimed is:

1. A two-wheeled vehicle history and loss management system using BLE and wireless communication that includes a non-communication type beacon sensor (10a) or a communication type beacon sensor (10b) attached to a handle of a two-wheeled vehicle and a user mobile terminal (80) in which a user's app is installed, the system comprising:
broadcasting a beacon ID through a beacon transmitting unit (11) according to generation of movement sensing information of the two-wheeled vehicle by an accelerometer (13) of the non-communication type beacon sensor (10a) or the communication type beacon sensor (10b), transmitting the beacon ID to the user mobile terminal (80) through BLE communication using a push message, and implementing the push message as a UI screen by the user's app.

2. The system according to claim 1,
wherein the non-communication type beacon sensor (10a) or the communication type beacon sensor (10b) further includes
a 1600 mA battery (14) configured to supply power to the beacon transmitting unit (11), a control unit (12) and the accelerometer (13).

3. The system according to claim 2,
wherein the communication type beacon sensor (10b) further includes
a wireless communication module (16) configured to transmit movement sensing information and the beacon ID to a target object via an IP network (20); and
a GPS receiver (15) configured to receive location information from GPS satellites.

4. The system according to claim 3,
wherein the non-communication type beacon sensor (10a) and the communication type beacon sensor (10b) register the beacon ID in a DB management server (60) according to data transmission with a mobile server (50) through a user's app (80a) and perform history management of the two-wheeled vehicle based on the beacon ID.

5. A two-wheeled vehicle history and loss management method using BLE and wireless communication, comprising:
a first operation in which a non-communication type beacon sensor (10a) or a communication type beacon sensor (10b) broadcasts a beacon ID through a beacon transmitting unit (11) according to generation of movement sensing information of a two-wheeled vehicle by an accelerometer (13); and
a second operation in which the non-communication type beacon sensor (10a) or the communication type beacon sensor (10b) transmits the beacon ID to a user mobile terminal (80) through BLE communication using a push message, and the push message is implemented as a UI screen by a user's app.

6. The method according to claim 5, further comprising
before the first operation, registering, by the non-communication type beacon sensor (10a) or the communication type beacon sensor (10b), the beacon ID in a DB management server (60) according to data transmission with a mobile server (50) through a user's app (80a), and performing, by a smart two-wheeled vehicle service platform (40), history management of the two-wheeled vehicle based on the beacon ID.
